(19) United States
(12) Patent Application Publication
(10) Pub. No.: US 2022/0207602 A1
(43) Pub. Date: Jun. 30, 2022

(54) SYSTEMS AND METHODS FOR ANALYZING FINANCIAL PRODUCT UTILIZATION

(71) Applicant: FIDELITY INFORMATION SERVICES, LLC, Jacksonvile, FL (US)

(72) Inventors: Usha BALAKRISHNAN, Chennai (IN); Priya DHARMENDRAN, Milton, GA (US); William EGGERS, Buford, GA (US); Prabal GHOSH, Whitefield (IN); Paul PRYOR, Staunton, VA (US)

(73) Assignee: FIDELITY INFORMATION SERVICES, LLC

(21) Appl. No.: 17/181,313

(22) Filed: Feb. 22, 2021

(30) Foreign Application Priority Data
Dec. 24, 2020 (IN) 202011056323

(51) Int. Cl. G06Q 40/02; G06N 5/04; G06N 20/00; G06F 16/26

(52) U.S. Cl. CPC G06Q 40/02; G06F 16/26; G06N 20/00; G06N 5/04

(57) ABSTRACT

Computer-implemented systems and methods for analyzing financial data include, obtaining, from at least one data store, at least one historical data record associated with a financial institution, aggregating the at least one historical data record based on related attributes in the one or more data records, generating a predictive model configured to predict future BIN utilization, using the historical data records, training the predictive model, obtaining, from at least one data store, at least one non-historical data record associated with the financial institution, determining, by applying the predictive models to the non-historical data records, one or more BINs that do not meet a predetermined utilization and generating a visualization of at least one of the non-historical or historical data records, wherein the visualization includes an indication of BINs that do not meet the predetermined utilization.

### RELATED APPLICATIONS

This application claims the benefit of priority under 35 U.S.C. §119(a) to Indian Patent Application No. 202011056323, filed Dec. 24, 2020 and entitled “SYSTEMS AND METHODS FOR ANALYZING FINANCIAL PRODUCT UTILIZATION”, which is hereby incorporated by reference in its entirety.

### TECHNICAL FIELD

The present disclosure generally relates to computerized methods and systems for processing financial data and providing analysis and insights generated through machine learning training and models of financial product utilization.

### BACKGROUND

Financial institutions offer a variety of financial services and products. Many of these products take the form of different types of credit or debit cards that offer different incentives or features. Financial institutions differentiate between these products using a bank identification number or BIN.

Each payment card product provided by a financial institution can utilize multiple BIN numbers and the payment cards include the BIN number as part of the account number. Financial institutions must buy the right to use a BIN from a payment processor such as Visa or MasterCard.

To ensure that BINs are efficiently used, payment processors often charge hefty fees for BINs that are under-utilized. The payment processors may define under-utilization as BINs for which there are not a threshold number of transactions over a given period of time such as a month.

Calculating and predicting which BINs are under-utilized presents a technical challenge. Because a fee is incurred only after a BIN becomes under-utilized, technologies that can predict when such a scenario is likely to occur are needed.

Additionally, payment processors provide only historical data regarding financial transactions and BIN utilization, after fees have already been calculated and assessed. There is a need to be able to process and analyze BIN utilization data in real-time or near real-time to allow for advanced analytics, predictive modeling, and management of BIN use before fees are incurred.

### SUMMARY

One aspect of the present disclosure is directed to a computer-implemented system. The system comprises a non-transitory computer-readable medium configured to store instructions and at least one processor configured to execute the instructions to perform operations. The operations include obtaining, from at least one data store, at least one historical data record associated with a financial institution, aggregating the at least one historical data record based on related attributes in the data records, generating a predictive model configured to predict future BIN utilization, using the at least one historical data record, training the predictive model, obtaining, from at least one data store, at least one non-historical data record associated with the financial institution, determining, by applying the predictive models to the at least one non-historical data record, one or more BINs that do not meet a predetermined utilization and generating a visualization of at least one of the non-historical or historical data records, wherein the visualization includes an indication of BINs that do not meet the predetermined utilization.

Other aspects of the present disclosure are directed to computer-implemented methods for performing the functions of the computer-implemented systems discussed above.

Other systems, methods, and computer-readable media are also discussed herein.

### BRIEF DESCRIPTION OF THE DRAWINGS

FIG. 1 is a schematic diagram of an example system for processing or analyzing a financial transaction, consistent with the disclosed embodiments.

FIG. 2 is a block diagram of an example server computer system for processing or analyzing a financial transaction, consistent with the disclosed embodiments.

FIG. 3 depicts an example payment card used in the system shown in FIG. 1, consistent with the disclosed embodiments

FIG. 4 is a block diagram of an example analysis network used in the system shown in FIG. 1, consistent with the disclosed embodiments.

FIG. 5 depicts an example dashboard for analyzing financial information captured using the system shown in FIG. 1, consistent with the disclosed embodiments.

FIGS. 6A-6B depict example visualizations for analyzing financial information captured using the system shown in FIG. 1, consistent with the disclosed embodiments

FIG. 7 is a flowchart of an example process for analyzing financial data in the system shown in FIG. 1, consistent with the disclosed embodiments.

FIG. 8 is a flowchart of an example process for optimizing financial product usage in the system shown in FIG. 1, consistent with the disclosed embodiments.

FIG. 9 is a flowchart of an example process for analyzing and generating alerts for financial data in the system shown in FIG. 1, consistent with the disclosed embodiments.

### DETAILED DESCRIPTION

The disclosed embodiments include systems and methods for analyzing and predicting BIN utilization. Before explaining certain embodiments of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the accompanying drawings, are for the purpose of description and should not be regarded as limiting.

As such, those skilled in the art will appreciate that the conception upon which this disclosure is based may readily be utilized as a basis for designing other structures, methods, and systems for carrying out the several purposes of the present disclosure.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Reference will now be made in detail to the present example embodiments of the disclosure, examples of which are illustrated in the accompanying drawings. Wherever possible, the same reference numbers will be used throughout the drawings to refer to the same or like parts.

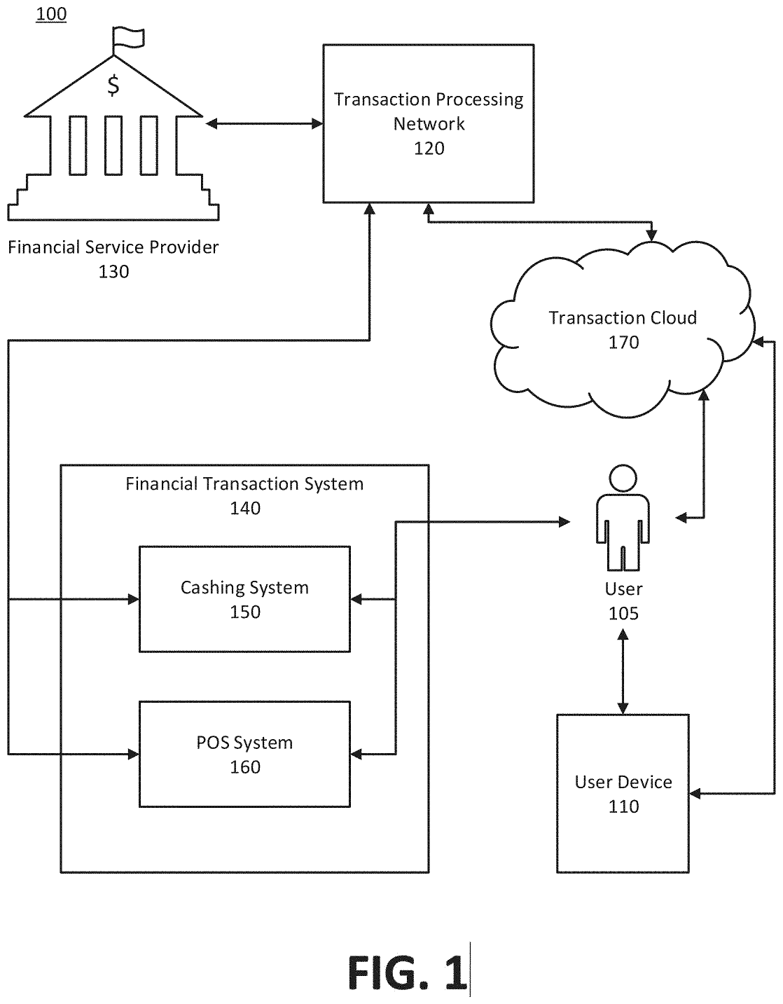

FIG. 1 is a schematic diagram illustrating an example system 100 for processing a financial transaction, consistent with the disclosed embodiments. For example, the financial transaction processed by system 100 may be in the form of check payments, debit card payments, credit card payments, electronic payment made through the Automated Clearing House (ACH) Network, Real-Time Payment Network, wire transfers, electronic payments, peer-to-peer payments, mobile payments (e.g., Apple Pay®), electronic fund payment (e.g., Zelle®), or the like. Moreover, the payments processed by system 100 may include recurring payments, such as payments of utility bills, providing paychecks to an employee through direct deposits, mortgage payments, or the like. As shown in FIG. 1, system 100 includes transaction processing network 120, financial service provider 130, financial transaction system 140, and transaction cloud 170.

In FIG. 1, transaction processing network 120 may include one or more computer systems associated with one or more financial entities, such as a financial service provider 130. Transaction processing network 120 may be an Interbank Network (such as NYCE®, INTERAC®, or the like). Interbank Networks allow money systems (such as ATMs or payment terminals) to access deposit or other accounts. In some embodiments, transaction processing network 120 may enable the use of ATM cards issued by a bank to be used at a point of sale through an EFTPOS (Electronic Fund Transfer at Point of Sale) system. Rather than operating as a credit card transaction, which would typically need to go through a credit card issuer system, an EFTPOS transaction could be received by transaction processing network 120 and routed to the appropriate bank holding the account.

In some embodiments, transaction processing network 120 may provide transaction processing service between user 105 and one or more financial service provider 130 through financial transaction system 140, such as a cashing system 150 (e.g., ATM) or a point-of-sale (POS) system 160. Consistent with the present disclosure, transaction processing network 120 receives one or more requests for processing transactions initiated by user 105 (e.g., by a card swipe, a mobile payment, an online payment, or the like) or financial transaction system 140. In the disclosed embodiments, transaction processing network 120 may be developed and operated by a third-party service provider authorized by financial service provider 130 to process financial transactions. In other embodiments, transaction processing network 120 may be associated with one or more financial service provider 130 for processing financial transactions.

Transaction processing network 120 may include one or more components that perform processes consistent with the disclosed embodiments. For example, transaction processing network 120 may include one or more computers (e.g., server computers, database systems, etc.) that execute software instructions programmed to perform, among other things, aspects of the disclosed embodiments, such as collecting data regarding transaction requests, collecting data regarding financial institutions (e.g., financial service provider 130), processing and analyzing the collected data to determine usage patterns associated with BINs, and generating visualizations and alerts related to the transactions.

In some embodiments, transaction processing network 120 may provide a connectivity infrastructure for enabling communication among the various entities and financial transaction system 140 and for processing and analyzing transactions and/or payment transfers. In some embodiments, transaction processing network 120 may be implemented as part of or in conjunction with a Local Area Network (LAN) or a Wide Area Network (WAN) (such as the Internet) and may be a single network or a combination of networks. In some embodiments, transaction processing network 120 may be implemented as a single type of network or a combination of different types of networks (e.g., networks for wireline and/or wireless communications). In some embodiments, transaction processing network 120 may also utilize cloud computing technologies (e.g., for storage, caching, or the like). In some embodiments, transaction processing network 120 can be national, international, or both. It should be noted that transaction processing network 120 is not limited to the above examples, and system 100 may implement any type of network that allows the entities (shown and not shown) included in FIG. 1 to exchange data and information.

Financial service provider 130 may be an entity that provides financial services. For example, financial service provider 130 may be a bank, a check clearinghouse, or another type of financial service entity that configures, offers, provides, and/or manages financial service accounts, such as checking accounts, savings accounts, debit card accounts, credit card accounts, loyalty accounts, etc. These financial service accounts may be used by user 105 to purchase goods and/or services. Financial service provider 130 may include one or more components that perform processes consistent with the disclosed embodiments. The computer systems of financial service provider 130 may be communicatively connected to computer systems in transaction processing network 120. In some embodiments, one or more components in both financial service provider 130 and transaction processing network 120 may cooperate to perform processes consistent with the disclosed embodiments.

Financial transaction system 140 may include one or more of cashing system 150 or POS system 160. Cashing system 150 may be implemented as a computer or other electronic device operable to receive a cash withdrawal transaction request from user 105. In some embodiments, cashing system 150 may be implemented as an automated teller machine (ATM) configured to receive data associated with user 105. In other embodiments, cashing system 150 may be implemented at one or more retail locations. Transaction processing network 120 associated with cashing system 150 may receive an account number from user 105 (e.g., by a card swipe) and transmit a cash withdrawal transaction request to transaction processing network 120. The processor associated with cashing system 150 may also receive a cash withdrawal transaction request from user device 110 (e.g., an authenticated smartphone) associated with user 105 through an application program interface (API). Cashing system 150 may be configured to receive instructions from transaction processing network 120 for dispensing cash to user 105. Transaction processing network 120 can store information about cash withdrawal transaction requests for later, real-time, or near real-time analysis.

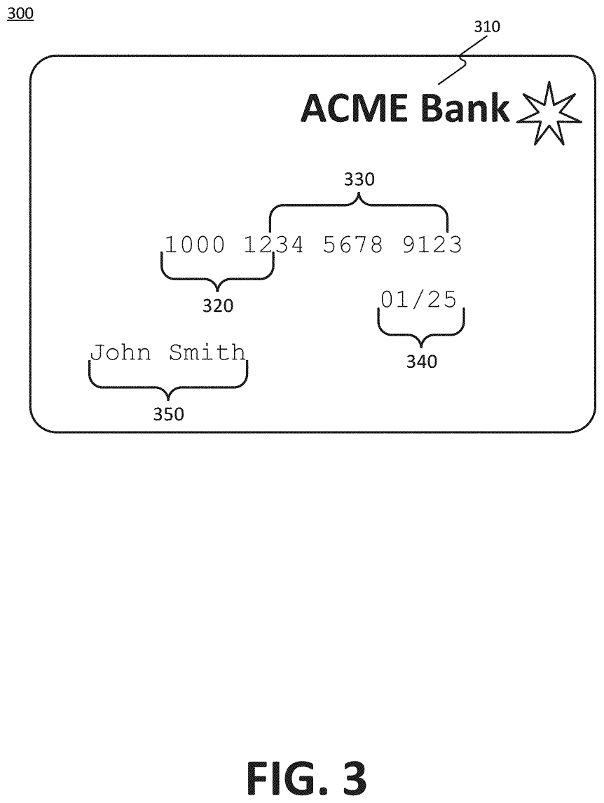

POS system 160 may be a computer system or other electronic device operable to transmit a POS transaction request for completing a financial transaction using a cash substitute. For example, POS system 160 may include a POS machine. The POS machine may receive an account number, such as account number shown on payment card 300 in FIG. 3, from user 105 (e.g., by a card swipe, a chip-card insertion, a contactless-card tap, or the like). In another example, POS system 160 may include a mobile payment machine that may receive the account number (e.g., by receiving an NFC tap, scanning a QR code, or the like) from user device 110 that provides a digital wallet (e.g., Apple Pay®, Google Pay®, Samsung Pay®, or the like). After receiving the account number, POS system 160 may transmit a POS transaction request that includes the account number to transaction processing network 120 or financial service provider 130 for identifying a financial account associated with user 105. In some embodiments, transaction processing network 120 or financial service provider 130 may send an additional request to POS system 160 to receive an identifier (e.g., a PIN number) for some types of transactions (e.g., a debit card transaction). POS system 160 may receive the identifier from user 105 (e.g., by receiving a keypad input) or user device 110 (e.g., by receiving a touchscreen input) and send the identifier to transaction processing network 120 to proceed the transaction. After the transaction being authorized by transaction processing network 120 or financial service provider 130, POS system 160 may receive an indication (e.g., a receipt, a text message, a push notification, an information page, or the like) from transaction processing network 120 that payment is authorized.

In some embodiments, POS system 160 may also be operable to split the monetary amount of the POS transaction request into more than one portion and create a corresponding number of POS transaction requests for completing the financial transaction using any combination of cash or one or more cash substitutes, which may allow a customer to utilize more than one mode of payment to pay for goods or services. In this case, POS system 160 may split the monetary amount and generate a corresponding number of POS transaction requests with the portions of the monetary amount. POS system 160 may then process each of the POS transaction requests.

In some embodiments, POS system 160 may be implemented as an attended machine (e.g., by a cashier or clerk) or an automated kiosk (e.g., by user 105 actuating a screen or buttons on an unmanned or cashier-less kiosks) operable to transmit a request for processing payment of the transaction to transaction processing network 120. In some embodiments, POS system 160 may be implemented as a personal computer, online terminal, or mobile device operating a software application configured to generate a transaction request and transmit the POS transaction request to transaction processing network 120. In some embodiments, POS system 160 may be a retail point-of-sale device, e-commerce website, or mobile application configured to receive account information.

In some embodiments, user 105 may initiate an electronic payment using user device 110. For example, user device 110 may be installed with applications such as Apple Pay® or Zelle®, which can be used to initiate a payment or fund transfer. User device 110 may be a mobile phone, a personal computer, a wearable device (e.g., a smartwatch, smart glasses, etc.), a messaging device, a gaming console, a tablet computer, a personal digital assistant, or the like.

In the previously described embodiments and in some other embodiments, transaction processing network may store information about each of the transactions for later, real-time, or near real-time analysis.

Transaction cloud 170 may provide a connectivity infrastructure for enabling communication among financial service provider 130 via transaction processing network 120, financial transaction system 140, and user device 110. Transaction cloud 170 may be implemented using a wireless network, a cellular network, a satellite network, or the like. Transaction cloud 170 may serve, for example, as a second communication channel, separate from the communication between transaction processing network 120 and financial transaction system 140, for verifying information during an initial registration process or during each transaction request to prevent fraudulent activity, in a manner consistent with the disclosed embodiments. In some embodiments, transaction processing network 120 can store information related to communications using transaction cloud 170 for later analysis, real-time analysis, or near-real time analysis.

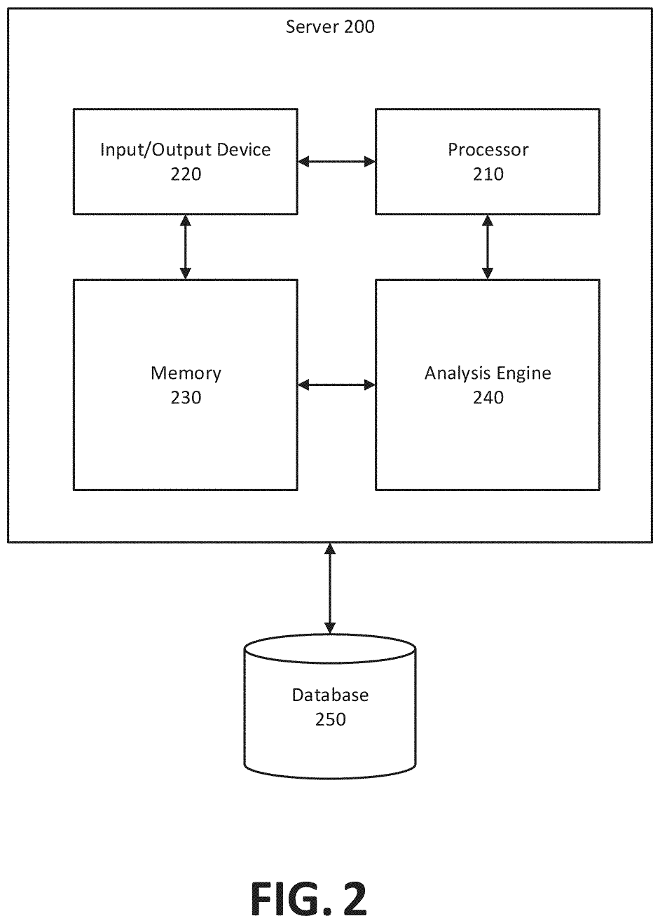

FIG. 2 is a block diagram of an example server computer system 200 (referred to as “server 200” hereinafter) used in system 100, consistent with the disclosed embodiments. For example, server 200 may be used in transaction processing network 120 or financial service provider 130. Server 200 may be one or more computing devices configured to execute software instructions stored in memory to perform one or more processes consistent with the disclosed embodiments. For example, server 200 may include one or more memory devices for storing data and software instructions and one or more hardware processors to analyze the data and execute the software instructions to perform server-based functions, operations, or analysis of data

In FIG. 2, server 200 includes a hardware processor 210, an input/output (I/O) device 220, a memory 230, and analysis engine 240. It should be noted that server 200 may include any number of those components and may further include any number of any other components. Server 200 may be standalone, or it may be part of a subsystem, which may be part of a larger system. For example, server 200 may represent distributed servers that are remotely located and communicate over a network.

Processor 210 may include or one or more known processing devices, such as, for example, a microprocessor. In some embodiments, processor 210 may include any type of single or multi-core processor, mobile device microcontroller, central processing unit, etc. In operation, processor 210 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in memory 230, processor 210, or elsewhere.

I/O device 220 may be one or more devices configured to allow data to be received and/or transmitted by server 200. I/O device 220 may include one or more customer I/O devices and/or components, such as those associated with a keyboard, mouse, touchscreen, display, etc. I/O device 220 may also include one or more digital and/or analog communication devices that allow server 200 to communicate with other machines and devices, such as other components of system 100. I/O device 220 may also include interface hardware configured to receive input information and/or display or otherwise provide output information. For example, I/O device 220 may include a monitor configured to display a customer interface.

Memory 230 may include one or more storage devices configured to store instructions used by processor 210 to perform functions related to disclosed embodiments. For example, memory 230 may be configured with one or more software instructions associated with programs and/or data.

Memory 230 may include a single program that performs the functions of the server 200, or multiple programs. Additionally, processor 210 may execute one or more programs located remotely from server 200. Memory 230 may also store data that may reflect any type of information in any format that the system may use to perform operations consistent with disclosed embodiments. Memory 230 may be a volatile or non-volatile (e.g., ROM, RAM, PROM, EPROM, EEPROM, flash memory, etc.), magnetic, semiconductor, tape, optical, removable, non-removable, or another type of storage device or tangible (i.e., non-transitory) computer-readable medium.

Consistent with the disclosed embodiments, server 200 includes analysis engine 240 configured to process transaction information, customer data, payment card data, or other financial information. Analysis engine 240 may be implemented as software (e.g., program codes stored in memory 230), hardware (e.g., a specialized chip incorporated in or in communication with processor 210), or a combination of both. Analysis engine 240 can be implemented in any general programming language and may also be implemented using optimized languages for particular tasks such as machine learning or statistical analysis (e.g., the R programming language). Analysis engine can process financial data provided through, for example, input/output device 220 and generate output models, visualizations, or other conclusions based on the input data. In some embodiments, analysis engine 240 may analyze or combine multiple data sets from multiple data sources. In some embodiments, analysis engine can continuously process an input data stream and generate updated analysis as new data is received. Analysis engine 240 may utilize machine learning techniques to improve the analysis of input data. In these embodiments, analysis engine 240 can learn from previous data and analysis to constantly improve its predictive models and analysis as more data is processed.

Server 200 may also be communicatively connected to one or more databases. For example, server 200 may be communicatively connected to database 250. Database 250 may be a database implemented in a computer system (e.g., a database server computer) in transaction processing network 120 or financial service provider 130. Database 250 may include one or more memory devices that store information and are accessed and/or managed through server 200. By way of example, database 250 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, server 200 may include database 250. Alternatively, database 250 may be located remotely from the server 200. Database 250 may include computing components (e.g., database management system, database server, etc.) configured to receive and process requests for data stored in memory devices of database 250 and to provide data from database 250.

FIG. 3 depicts an example payment card 300 used in system 100, consistent with the disclosed embodiments. Payment card 300 can represent a credit card, debit card, or other payment card that may permit the cardholder to complete a financial transaction. Payment card 300 can include bank 310. Bank 310 can identify the bank that issued the payment card. Payment card also includes an account holder name 350 and expiration date 340. Payment card 300 can include an account number. The account number may include a bank identification number (BIN) 320, account identifier 330, and a check digit (which may be part of the account identifier 330). Account identifier can be used to determine which account is being used for payment and expiration data 340 and name 350 may be used to verify transactions.

BIN 320 may be used to identify specific programs or types of payment cards. For example, different financial institutions (e.g., financial service provider 130 of system 100) can offer a variety of different payment card types with different incentives, features, or other offerings. Each of these different financial products or offerings may be assigned one or more BIN numbers and payment cards 300 that are part of a particular financial product or offering include the assigned number as BIN 320. A particular BIN is obtained from a payment card processor (e.g., Visa or MasterCard) for use with a particular set of payment cards 300.

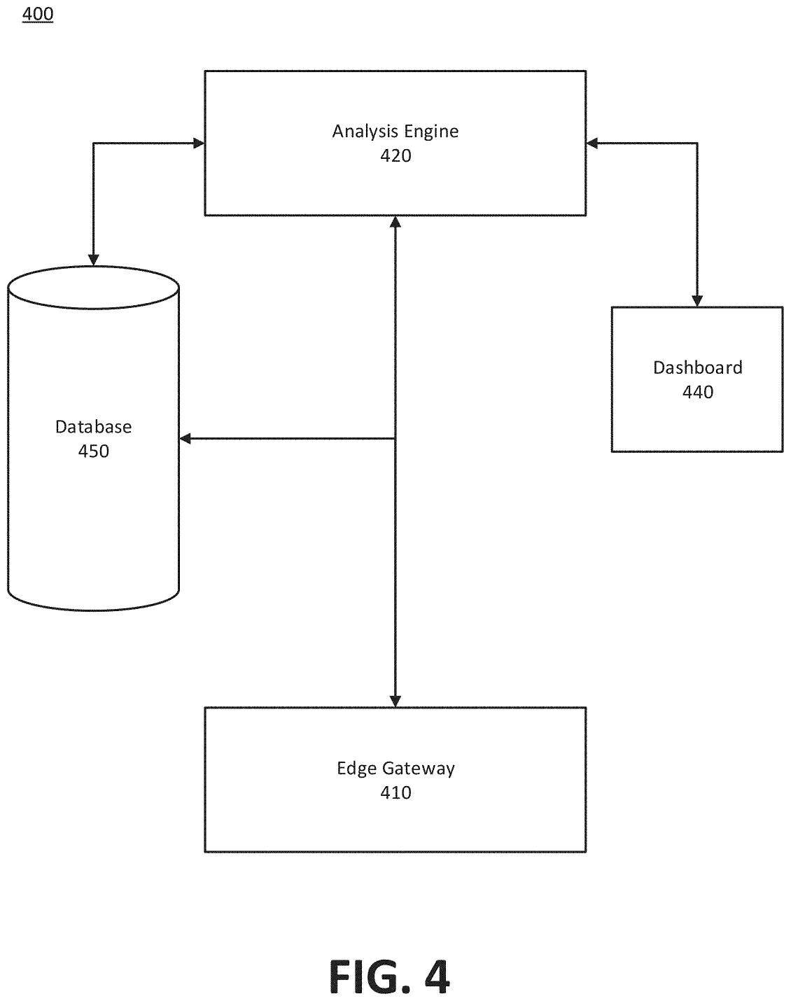

When for example, transaction processing network 120 of system 100 processes a transaction, transaction processing network 120 can store transaction details that include BIN 320, account identifier 330, expiration date 340, and name 350. The number of transactions may be tracked on a per BIN basis. In some embodiments, if a threshold number of transactions are not made for a particular BIN in a particular period of time, the BIN may be considered to be under-utilized. Payment card processors (e.g., VISA or MasterCard), may charge expensive fees for the use of under-utilized bins. But payment processors only provide historical data after fees have already been assessed. By tracking usage by BIN from systems within transaction processing network 120 and other components of system 100, the embodiments of the present disclosure described in FIGS. 4-9 and used in conjunction with embodiments described in FIGS. 1 and 2, can provide analyze the data being generated by different parts of the system in real time or near-real time to provide immediate information about BIN utilization. Additionally, the data captured by transaction processing network 120 can analyzed using predictive models. Accordingly, the embodiments disclosed herein can allow financial institutions (e.g., financial service provider 130) to both generate advanced BIN utilization analytics in real-time or near real-time and predict BINs that may become under-utilized in the future by using machine learning models specifically trained to predict BIN Utilization.

FIG. 4 is a block diagram of an example analysis network 400 used in system 100, consistent with the disclosed embodiments. As shown in FIG. 4, analysis network 400 may include an edge gateway 410, analysis engine 420, dashboard 440 and database 450. In some embodiments, analysis network 400 may include additional components. In some embodiments, the components of analysis network 400 can be split among additional components, can be part of the same component, or can be separated across a network such as a LAN or WAN. In some embodiments the components of analysis network 400 can be part of, for example, transaction processing network 120 of system 100. In other embodiments, analysis network 400 can be implemented as part of financial service provider 130 of system 100.

The elements of analysis network 400 can be implemented on, for example, server 200. For example, analysis engine 420 of analysis network 400 can be the same as analysis engine 240 of server 200. In some embodiments, database 450 can be the same as database 250 of server 200. The components of analysis network 400, such as analysis engine 420, dashboard 440, and edge gateway 410, may be implemented as software (e.g., program codes stored in memory 230), hardware (e.g., a specialized chip incorporated in or in communication with processor 210), or a combination of both.

Edge gateway 410 may be a high availability or highly scalable server or set of servers that can receive and process transaction requests and communications of system 100, such as those originating from financial transaction system 140. Edge gateway 410 may forward transaction requests to analysis engine 420 or store transaction request data in database 450 for later use. Edge gateway 410 may also provide transaction requests to financial service provider 130 or other components of system 100.

Database 450 may be a single database or can be split across different databases or servers on the same device or network or distributed across multiple devices and networks and connected via a network or other communication network. In some embodiments, database 450 may be the same as database 250 of server 200. Database 450 may be implemented in the same way as described with respect to database 250 above and may, for example, include Oracle™ databases, Sybase™ databases, or other relational databases or non-relational databases, such as Hadoop sequence files, HBase, or Cassandra. Database 450 may store, among other types of data, transaction data, card data, financial institution data, BIN data, or account data. Database 450 may store predictive models and training data used for training machine learning models used by, for example, analysis engine 420.

Analysis engine 420 may process transaction data and other financial data stored in database 450 or provided through edge gateway 410. As described above, analysis engine 420 may process transaction data, card data, financial institution data, BIN data, or account data. Analysis engine 420 may use any other data related to financial transactions or products, services, or other offerings identified by BINs.

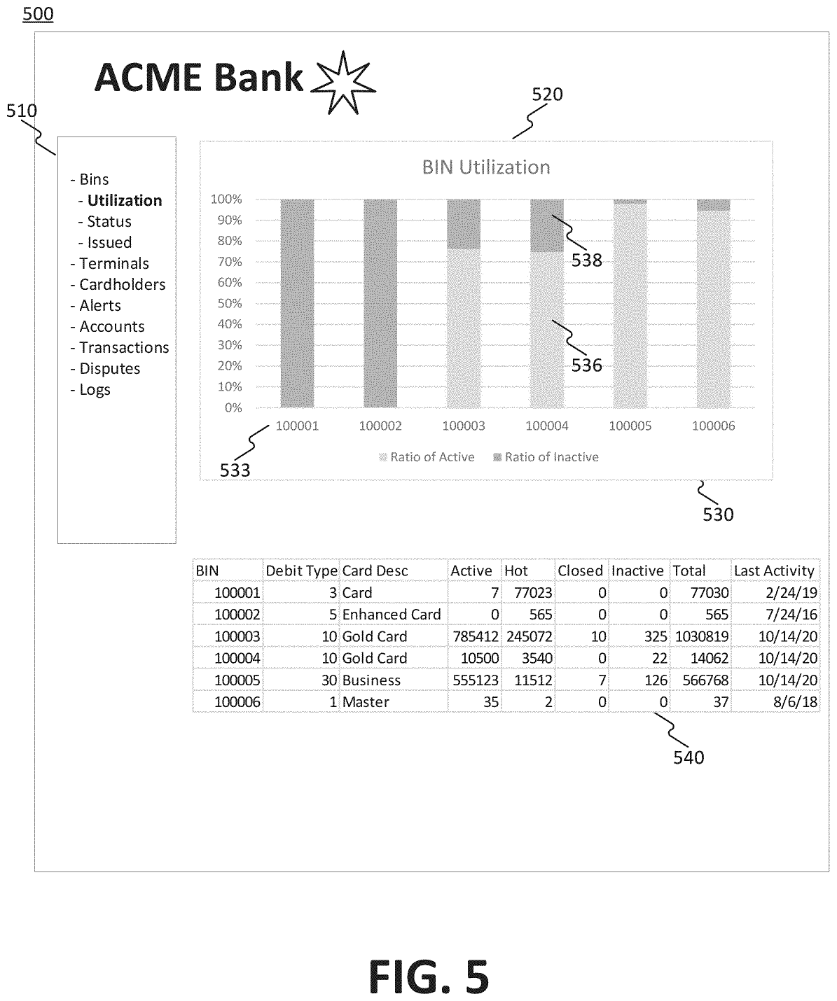

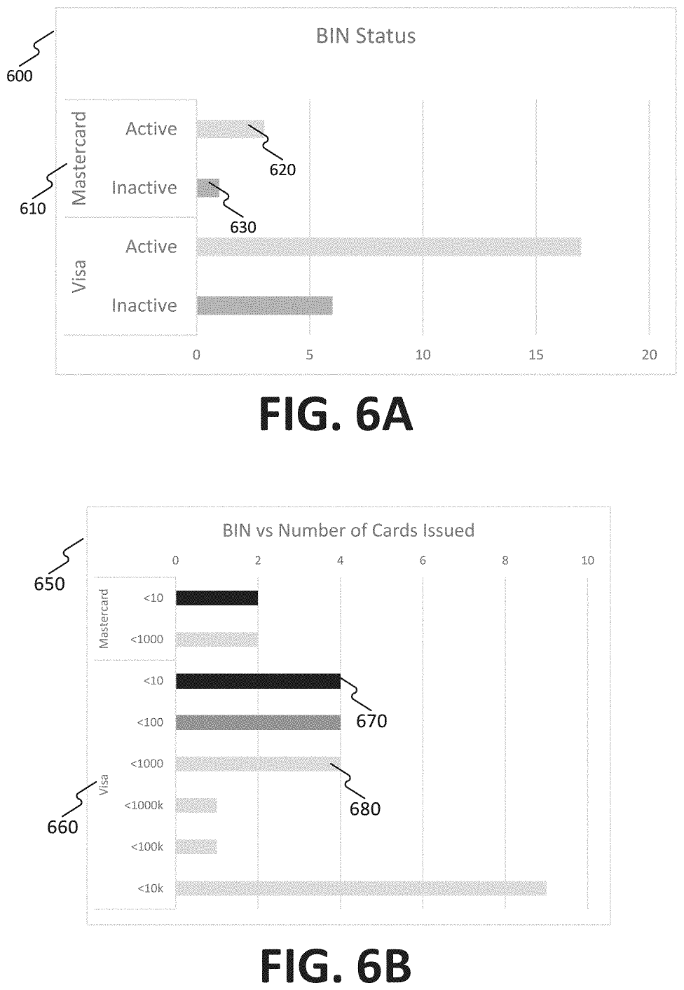

Analysis engine 420 may aggregate or combine data from different data sources. In some embodiments, analysis engine 420 may generate visualizations of the aggregated data for display on dashboard 440. For example, the visualization, described in more detail below in reference to FIGS. 5 and 6A-6B, can provide insight into how different BINs are utilized. In this example, the visualization can provide a summary of BINs that do not meet threshold limits for required number of transactions over a predetermined period of time. BINs not meeting such thresholds can result in expensive fees.

In addition to providing visualizations of BIN utilization and other financial transaction data, analysis engine 420 may calculate and predict which BINs may be repurposed for new products or services. Analysis engine 420 may use available past transaction data to train models that calculate the expected changes in transactions related to a particular BIN. In some embodiments, the changes can be calculated on a monthly basis. Analysis engine 420 may use the models, trained on past financial data, to predict BINs that may become underutilized in the future, resulting in fees. By using machine learning to train and utilize predictive models, analysis engine 420 may determine BINs at risk of underutilization based on factors or combinations of factors that may have previously been ignored.

Analysis engine 420 can clean the input data by for example, formatting the data in the data sources to a consistent format, normalizing data to a consistent scale, or by utilizing other well known data preparation techniques. Cleaning the data can allow data from multiple data sources, that may store data in different ways, to be used together. Analysis engine 420 can model bin utilization using a multiple linear regression on the data inputs to determine the relationship of the various input variables as they relate to the estimated BIN status. For example, analysis engine can use the following equation:

Yn=βo+β1x1+β2X2+β3X3+β4X4+ . . . +βnXn.

In the above equation, Y is the dependent variable representing Bin Status, X is an explanatory variable such as, for example, card status, card activity, response codes, transaction types, or last activity. βn can represent the slope coefficient for each explanatory variable and βo is the intercept constant.

Analysis engine 420 can review the output of the linear regression module to identify potential ways to improve the model. For example, multicollinearity can occur when independent variables exhibit high correlation but are not significant. Analysis engine can remove one or more of the highly correlated independent variables and then define a new regression to model BIN utilization. In another example, analysis engine 420 can define a new variable equal to a linear combination of the highly correlated variables and define a new regression equation, using the new variable in place of the highly correlated variables. In some embodiments, principal component analysis can be used to reduce the data inputs to the linear regression model.

Analysis engine 420 can further run model classification techniques to further refine the linear regression. For example, analysis engine 420 can use, among other things, a Classification and Regression Tree (CART), a Random Forest, or Support Vector Machine. Other algorithms can be used in the predictive model to improve performance including, among other things, k-nearest neighbor or ensemble classification algorithms.

Analysis engine 420 can continuously monitor new data generated by system 100. In these embodiments, analysis engine 420 can use the newly available data to further train the predictive models and improve the performance of analysis network 400.

In some embodiments, analysis engine 420 can monitor continuously generated financial data and generate alerts to notify a user that certain criteria or thresholds have been met. A user or administrator of, for example financial service provider 130, may use dashboard 440 or other interfaces to configure analysis engine 420. Analysis engine 420 may be configured to identify specific conditions. When analysis engine 420 detects that the configured conditions have been met, analysis engine 420 can generate alerts. Analysis engine 420 may send, via a cellular or wireless communications network, alerts to specified individuals or connected systems. By way of example, alerts may be sent via text message, e.g., short message service (SMS) or multimedia message service (MMS), push notifications, electronic mail, automatic calling, or any other suitable communication protocol. In some embodiments, the alerts can be displayed on dashboard 440. Analysis engine 420 may generate alerts or notifications at regular, pre-determined intervals or, in some embodiments, in real-time or near real-time.

Dashboard 440 may include a graphical interface (e.g., a display panel) for providing visual information to a user. For example, the display panel may include a liquid crystal display (LCD), a light-emitting diode (LED), a plasma display, a projection, or any other type of display. In some embodiments, dashboard 440 can be a local device or computer, such as a desktop computer, user terminal, mobile device, or laptop computer containing, for example, similar components to server 200 of FIG. 2. Dashboard 440 may be implemented as part of a natively executing application or software program. In some embodiments, dashboard 440 can be implemented on a server, such as server 200 of FIG. 2, and access through a network connection using a web browser, thin-client, or other similar application. In these embodiments, the dashboard data may be rendered on a server and transmitted to dashboard 440 via a communications network or the data may be transmitted via a communications network to dashboard 440 and rendered on a local device or computer.

In some embodiments dashboard 440 may be implemented as a widget, plug-in, or remote system call compatible with different applications or services. In these embodiments, dashboard 440 may be an application programming interface (API) that provides raw data, images, or formatted output from analysis engine 420. In these embodiments, dashboard 440 can provide compatibility with different user interfaces, systems, display devices, and platforms, and improve interoperability. Dashboard 440 may be accessed remotely through a communications network.

Dashboard 440 may also be configured to receive input or commands from users or administrators of system 100. For example, the display panel may be implemented as a touch screen to receive input signals from the user. The touch screen includes one or more touch sensors to sense touches, swipes, and other gestures on the touch screen. The touch sensors may sense not only a boundary of a touch or swipe action but also a period of time and a pressure associated with the touch or swipe action. Alternatively, or additionally, dashboard 440 may include other input devices such as keyboards, buttons, joysticks, and/or trackballs. Dashboard 440 may be configured to send the user input to analysis engine 420.

FIG. 5 depicts an example dashboard 500 for analyzing financial information from system 100 of FIG. 1, consistent with the disclosed embodiments. Dashboard 500 includes various user interface elements to allow a user to navigate dashboard 500. In some embodiments, dashboard 500 may be displayed on dashboard 440 of analysis network 400 shown in FIG. 4. Dashboard 500 may be a graphical user interface running in a web browser, thin client, or in an application executing on a computing device (e.g., on dashboard 440 of analysis network 400).

As shown in FIG. 5, dashboard 500 can include menu 510, visualization area 520 and data area 540. In some embodiments visualization area 520 can include visualization 530 and data area 540 can include a spreadsheet or listing of data shown in visualization 530. This layout and list of components is exemplary. In some embodiments, multiple visualizations can be displayed at the same time and the visualization shown in visualization area 520 can change based on interaction from the user. In other embodiments, data area 540 can be displayed or hidden. Additionally, the components of dashboard 500 can be laid out in a variety of orientations with each component having different sizes and position. The depiction shown in FIG. 5 is intended to be exemplary and one of ordinary skill in the art would understand that different layouts may be used and some or all of the components shown in dashboard 500 may be included on dashboard 500. In some embodiments additional components may be displayed on dashboard 500. Additional possible dashboard elements are described in more detail in FIGS. 6A and 6B.

As shown, dashboard 500 can include data visualization 530. Data visualization 530 may show the BIN utilization of different BINs used by, for example, financial service provider 130 of system 100. Data visualization 530 can be a representation of the data shown in data area 540 and can be generated using, for example, analysis engine 420 of analysis network 400, shown in FIG. 4. In some embodiments, data visualization 530 can show only a subset of the underlying data. For example, data visualization 530 does not include a representation of the “Last Activity” column that is shown in data area 540. Additionally, in some embodiments, the visualization shown in data visualization 530 can be based on further calculations or analysis of the data shown in data area 540. For example, data visualization 530 includes a bar graph for each BIN 533. Each bar includes a range from 0 to 100% and includes the ratio of active payment cards (e.g., payment cards 300 of FIG. 3) to the total number of issued payment cards and the ratio of inactive payment cards to the total number of issued cards. In this example, inactive cards can include both the data in the inactive column of data area 540 as well as payment cards identified as “Hot” or “Closed” because those cards will not be used for valid payment transactions and can be considered inactive or non-active payment cards. In this way, data visualization 530 can combine different aspects of the underlying in the visualization. Because the total is the sum of inactive and active payment cards, each bar in the data visualization 530 shows values from 0% to 100% utilization. Because utilization of a BIN is based on the number of active payment cards, each bar graph can indicate what percentage of the total payment cards are active and what percentage are inactive. For example, as shown in data visualization 530, the bar for BIN “100004” includes a light gray bar 536 showing that approximately 75% of the payment cards for BIN “100004” are active. The remaining dark gray bar 538 that occupies the remaining approximately 25% of the bar for BIN “100004” shows that approximately 25% of payment cards for BIN “100004” are inactive. Accordingly, in this example, data visualization 530 can provide efficient insight into the amount of utilization for each of the BINs that would not otherwise be readily apparent from the data shown in data area 540.

As described above, data visualization 530 may be generated by analysis engine 420 of analysis network 400. In some embodiments, analysis engine 420 may use data and visualizations generated for use in visualization area 520 of dashboard 500 to generate alerts or notifications. For example, if analysis engine 420, in the process of generating data visualization 530, identifies that the active BIN utilization for certain BINs has dropped below a predetermined threshold, analysis engine 420 can generate alerts or notifications about under-utilization. In some embodiments the threshold may be determined based on predictive models generated using machine learning analysis and may represent a utilization that may lead to fees for under-utilization at some point in time in the future. For example, analysis engine can use machine learning techniques like those described above in relation to FIG. 4. In these embodiments, analysis engine 420 may adjust the threshold based on analysis of new data or models and update data visualization 530 as new data is processed.

Analysis engine can add visual cues to data visualization 530 indicating the alerts or notifications. For example, a BIN or the bar graph may be shown in red to quickly indicate BINs falling below the threshold. Because analysis engine 420 is constantly monitoring and processing new transaction data, analysis engine 420 can process and update data visualization 530 in near real-time or real-time.

FIGS. 6A-6B depict example data visualizations 600 and 650 for analyzing financial information captured using system 100 of FIG. 1, consistent with the disclosed embodiments. As shown in FIGS. 6A and 6B, data visualization 600 can show BIN usage by different payment processors and data visualization 650 can show how many bins have a threshold number of cards issued by payment processor. Each of these data visualizations is discussed in more detail below. Both data visualization 600 and data visualization 650 may displayed on dashboard 500, shown in FIG. 5, in visualization area 520. In some embodiments, both visualizations can be shown simultaneously on dashboard 500 and can be shown with data visualization 530. In other embodiments, different combinations of the visualizations can be shown on dashboard 500 at the same time. These combinations are exemplary, and it is appreciated by one of ordinary skill that the visualizations described may be combined with additional visualizations not described herein. Additionally, which data visualizations are displayed on dashboard 500 may be based on user input received through dashboard 500.

FIG. 6A depicts an example data visualization 600 that can show the number of BINs that are active and inactive for each payment processor. Each payment processor indicator 610 can include bars for the active (e.g., bar 620) and inactive (e.g., bar 630) bins. As shown in data visualization 600, the financial institution, e.g., financial service provider 130, under analysis has 3 active BINs for the “Mastercard” payment processor and 1 inactive BIN. Using data visualization 600, a user or financial service provider can determine what fees may be incurred for having inactive BINs. As described above with respect to data visualization 530, in some embodiments, analysis engine 420 can analyze new data in near real-time or real-time and update data visualization 600 accordingly. Additionally, analysis engine 420 can generate alerts or notifications if data calculated for data visualization 600 meets threshold criteria or changes in a significant way. For example, analysis engine 420 can generate an alert or notification if the number of inactive BINs increases from its current value. In other embodiments, analysis engine 420 may generate an alert or notification if the number of inactive BINs passes a predetermined threshold. As described above, the threshold may be set by an administrator or user of system 100 or the threshold may be calculated through the use of predictive models generated by machine learning. In these embodiments, the threshold could be set to identify scenarios when the various combinations of inactive BINs will result in fees exceeding a certain amount or when the various combinations of inactive BINs may likely result in unexpected fees at some future point in time based on current data. Analysis engine 420 can begin by processing historical data related to BIN utilization and the fees that were incurred from that utilization. Analysis engine 420 can consider features of the input data, such as raw utilization values, the types of transactions that contributed to the utilization, the time of year, regional differences. Analysis engine 420 can process each of the data records and determine how changes in various data values across data records affected the fees that were ultimately incurred. Through this process, analysis engine 420 can build a model to determine what thresholds of inactive BINs resulted in fees. Using that model, analysis engine 420 can apply the model to current data to set thresholds for generating alerts.

FIG. 6B depicts an example data visualization 650 that can organize the number of BINs that have a certain threshold of issued or active payment cards. For example, each payment processor can have a different section. As shown, payment processor 660 corresponds to data for payment cards processed by “Visa”. Each bar in the graph for payment processor 660 shows the number of Bins with issued cards falling in the category shown on the y-axis. For example, bar 670 shows that for this financial institution, e.g., financial service provider 130, there are 4 BINs that are processed by “Visa” that have less than 10 issued payment cards. In some embodiments, each subsequent category excludes the previous categories. For example, bar 680 may represent the number of BINs for processed by “Visa” that have less than 1000 issued payment cards, but 100 or more issued payment cards. In these embodiments, data visualization 650 may represent each BIN only once. In other embodiments, each bar can be the cumulative number of BINs meeting the criteria.

In some embodiments, data visualization can use different colors or other indicators to highlight information. For example, bar 670 can be a different color than the other bars, e.g., bar 680, to indicate that special attention should be given to the data represented by bar 670. In this example, low numbers of active cards can indicate BINs that may result in excessive fees. As describe above in relation to data visualization 600 and 530, analysis engine 420 can determine the particular indications or identifiers used in data visualization 650. Moreover, as analysis engine 420 processes new data, it may update data visualization 650 in real-time or near real-time. Analysis engine 420 can obtain threshold value used for indications or identifiers in data visualization 650 from a user or can determine such values using machine learning. Analysis engine 420 can use predictive models created using machine learning to identify threshold levels of issued cards per BIN that result in fees or may likely result in fees at a future point in time.

As described above in relation to FIGS. 4-6B, analysis engine 420 can make use of machine learning techniques to generate alerts and update visualizations such as data visualization 530, 600, and 650. It is appreciated that the threshold criteria for alerts can be specified by a user or administrator or determined through machine learning analysis of historical data. Moreover it is appreciated that in some embodiments, a user or administrator can specify criteria of interest, but analysis engine 420, through its use of machine learning to generate predictive models, can identify other criteria that is indicative that the specified criteria will be met at some future point in time. For example, an administrator may set a threshold amount of fees that a financial institution, e.g., financial service provider 130, does not want to exceed. Through analysis of historical data, analysis engine 420 can train predictive models and determine that different combinations of intermediate thresholds are likely to result in fees exceeding the specified amounts. For example, analysis engine 420 may determine, through training its models, that when a ratio of BINs with more than 10,000 active payment cards nevertheless has low per card utilization, it is likely that the BIN will result in excessive fees. In this example, analysis engine 420 may also determine that a ratio of BINs with less than 100 active payment cards but that exceed a per card threshold are not likely to result in excessive fees. In the above example, analysis engine 420 can obtain historical data owned by financial service provider 130 and generated by the various components of system 100. Analysis engine 420 can use the historical data and identify particular features of the input data. Analysis engine 420 can train the models by specifying what intermediate criteria are of interest. Using the above example, one model may be trained to use features of the input data to determine changes in per card transaction rates. Another model may be trained to use features of the input data to determine changes in the number of payment cards in a particular bin. These intermediate models may be combined to train a final predictive model that, based on changes in the output of the intermediate models, predicts how the combination of various input data would affect overall BIN utilization and, therefore, predicted fees. The trained models can be applied to data generated in real time to predict future utilization an overall fees that may be incurred.

In this example, analysis engine 420 can generate appropriate updates to, for example, data visualizations 530, 600, and 650, that can indicate BINs meeting the thresholds or criteria identified through machine learning. In this example, the conclusions identified by analysis engine 420 may not be readily apparent if only static criteria are used or if the analysis is done manually. Moreover, in this example, analysis engine 420 can generate new intermediate from the provided criteria or thresholds if analysis engine 420 determines from its training models that those intermediate criteria have predictive value for the provided criteria. Accordingly, an administrator or user of analysis engine 420 may not know what criteria are important for avoiding excess fees, but through using the machine learning aspects of analysis engine 420, the most relevant criteria can be identified and provide to a user through data visualizations 530, 600, or 650, or through alerts or notifications.

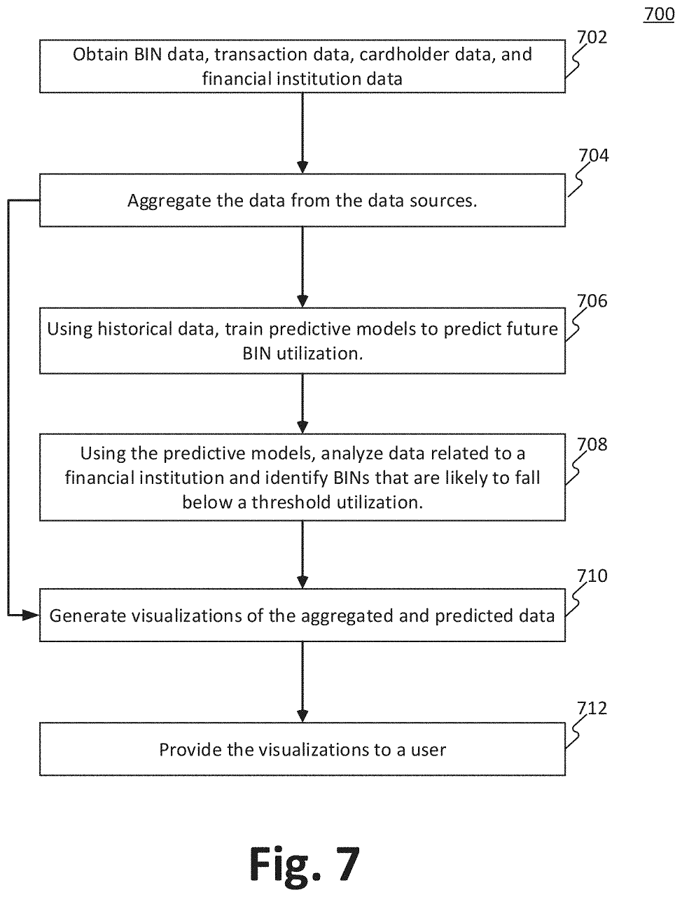

FIG. 7 is a flowchart of an example process 700 for analyzing financial data in system 100, consistent with the disclosed embodiments. Process 700 may be a process performed by a process performed by a computer-implemented system (e.g., server 200) in transaction processing network 120 or financial service provider 130. The computer-implemented system may include a memory (e.g., memory 230) that stores instructions and a processor (e.g., processor 210) programmed to execute the instructions to implement process 700. Process 700 may be connected to the analysis network and operations shown and described in FIGS. 3-4. For example, process 700 may be implemented as one or more software modules (e.g., an API in transaction analyzer 212) stored in memory 230 and executable by processor 210.

Referring to FIG. 7, at step 702, the processor may receive financial data from multiple data sources and from various components in system 100. The data may be stored in, for example, database 250, database 450, memory 230, or other components described above. The data may include, among other things, BIN data, cardholder data transaction data, or financial institution data.

Referring to FIG. 7, at step 704, the processor may aggregate the data received from the data sources. Because the data may originate from different systems, the data can be normalized so that common information has the same format and structure. For example, at step 704, the processor may normalize all account holder names to include three fields, first name, last name, and middle initial. In some embodiments, other data may be normalized such as addresses, financial institution names, date formats, or similar types of information. Additional examples of data normalization that the processor can apply to the input data includes, for example, identifying equivalent data through the use of phonetics, SOUNDEX, or Metaphone, removing extra whitespace, removing diacritics, or reformatting data, such as dates, phone numbers, and social security numbers into a standard format. After normalizing the data from the various data sources, the processor may combine or link the data records so that related data records can be easily inspected. For example, data that contains the account numbers can be broken into its component parts (e.g., BIN 320 and account identifier 330) and associated with, for example, other data sources that have information on the different BINs used by the financial institution. The processor may further use the aggregated data in step 710 and further process the aggregated data beginning at step 706.

Referring to FIG. 7, at step 706, the processor may analyze the historical data obtained and prepared in prior steps. The processor may create and train predictive models based on the usage patterns embedded in the historical data. Using various supervised, unsupervised, and semi-supervised training techniques, the processor can determine the predictive nature of different aspects of the data and different combinations of the data. For example, the processor can use machine learning to train models that determine what aspects of the historical data had the most value at predicting when BIN utilization dropped below a specified threshold. The processor can provide historical data as input and tell the system (e.g., analysis engine 420) the expected outcome and effect on, for example, BIN utilization, based on the historical data. To accomplish this, the processor can train and use machine learning models. The processor can obtain historical data related BIN utilization and the transactions that contribute to the utilization. The processor can determine features of the input data and, using those features, analyze how each of the features contributes to a known utilization. As the amount of historical input and output data is analyzed, the model may become better at predicting expected BIN utilization based on the inputs. The processor can store apply the predictive models to new data to make predictions. By using machine learning to train the models, bias regarding what data is the most significant can be removed and the processor can determine what data or combination of data has the most predictive value.

Referring to FIG. 7 at step 708, the processor can use the predictive models created in step 706 to analyze the data and determine which BINs are likely to fall below a threshold utilization value. As described above, the threshold utilization can be based on crossing a predetermined threshold or can be based on a prediction of the likelihood that BIN utilization will cross a threshold at some point in the future. The predictive nature of step 708 is important because once a threshold is crossed fees may be assessed. Accordingly predicting low BIN utilization before it actually occurs is important in order to properly manage BIN usage. It is also important not to identify BINs that, although nearing a utilization threshold, will not likely result in fees to avoid unnecessary restructuring or re-utilization of the BINs. In step 708, the processor can utilize the predictive model to better distinguish which BINs may cross a threshold before the threshold is actually crossed.

Referring to FIG. 7 at step 710, the processor can utilize the output of the predictive model applied to the data and use the original aggregated data to generate visualizations of the data. Example visualizations are described in detail above in respect to FIGS. 5-6B as data visualizations 530, 600, and 650. The visualizations can combine data and provide indications based on the output of step 708. The original data can be combined with the predictions from step 708 to indicate parts of the data that require attention. In step 712, the processor can provide visualization to a user. As shown above in FIGS. 4-6B, the visualizations can be provided through a dashboard (e.g., dashboard 440 and 500). Additionally, the visualization may be provided as data, images, rendered form, or in another data format through a software API or remote procedure call that allows a third-party system to display the visualizations. The visualizations can include one or more of data visualizations 530, 600, and 650 described above or may include additional views of the data and predictive models not otherwise described.

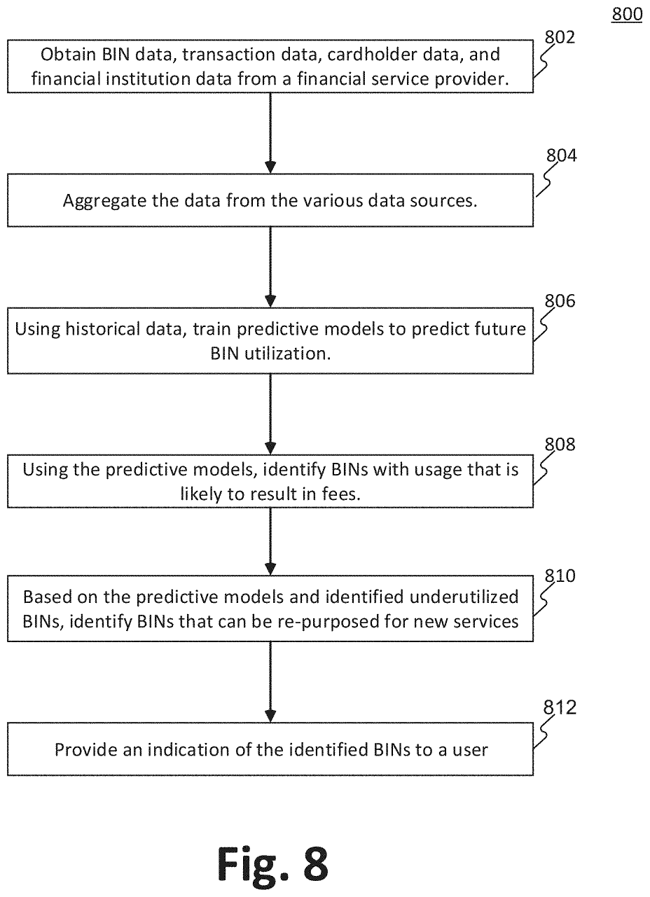

FIG. 8 is a flowchart of an example process 800 for analyzing financial data in system 100 and automated BIN utilization, consistent with the disclosed embodiments. Process 800 may be a process performed by a process performed by a computer-implemented system (e.g., server 200) in transaction processing network 120 or financial service provider 130. The computer-implemented system may include a memory (e.g., memory 230) that stores instructions and a processor (e.g., processor 210) programmed to execute the instructions to implement process 800. Process 800 may be connected to the analysis network and operations shown and described in FIGS. 3-4. For example, process 800 may be implemented as one or more software modules (e.g., an API in transaction analyzer 212) stored in memory 230 and executable by processor 210.

Referring to FIG. 8, at step 802, the processor may receive financial data from multiple data sources and from various components in system 100. The data may be stored in, for example, database 250, database 450, memory 230, or other components described above. The data may include, among other things, BIN data, cardholder data transaction data, or financial institution data.

Referring to FIG. 8, at step 804, the processor may aggregate the data received from the data sources. Because the data may originate from different systems, the data can be normalized so that common information has the same format and structure. For example, at step 804, the processor may normalize all account holder names to include three fields, first name, last name, and middle initial. In some embodiments, other data may be normalized such as addresses, financial institution names, date formats, or similar types of information. Additional examples of data normalization that the processor can apply to the input data includes, for example, identifying equivalent data through the use of phonetics, SOUNDEX, or Metaphone, removing extra whitespace, removing diacritics, or reformatting data, such as dates, phone numbers, and social security numbers into a standard format. After normalizing the data from the various data sources, the processor may combine or link the data records so that the processor may more easily analyze and manipulate the related data records. For example, the processor can split data that contains account numbers into component parts (e.g., BIN 320 and account identifier 330) and associate it with, for example, other data sources that have information on the different BINs used by the financial institution. In this example, because the account number used in a payment transaction includes the BIN number (e.g., BIN 320), the processor can extract the BIN for the payment transaction and use the bin number to associate the payment transaction with other records from the financial institution that are associated with the same BIN number.

Referring to FIG. 8, at step 806, the processor may analyze the historical data obtained and prepared in prior steps. The processor may create and train predictive models based on the usage patterns embedded in the historical data. Using various supervised and unsupervised training techniques, the processor can determine the predictive nature of different aspects of the data and different combinations of the data. For example, the processor can use machine learning to train models that determine what aspects of the historical data had the most value at predicting when BIN utilization dropped below a specified threshold. The processor can provide historical data as input and tell the system (e.g., analysis engine 420) the expected outcome and effect on, for example, BIN utilization, based on the historical data. To accomplish this, the processor can train and use machine learning models. The processor can obtain historical data related BIN utilization and the transactions that contribute to the utilization. The processor can determine features of the input data and, using those features, analyze how each of the features contributes to a known utilization. As the amount of historical input and output data is analyzed, the model may become better at predicting expected BIN utilization based on the inputs. The processor can apply the predictive models to new data to make predictions. By using machine learning to train the models, bias regarding what data is the most significant can be removed and the processor can determine what data or combination of data has the most predictive value.

The processor can provide historical data as input and tell the system (e.g., analysis engine 420) the expected outcome and effect on, for example, BIN utilization, based on the historical data. As the analysis engine 420 consumes more and more data, it can learn how to predict BIN utilization and other outcomes based on the data. The conclusions can be stored in predictive models that can be applied to new data to make predictions. By using machine learning to train the models, bias regarding what data is the most significant can be removed and the processor can determine what data or combination of data has the most predictive value.

Referring to FIG. 8 at step 808, the processor can use the predictive models created in step 806 to analyze the data and determine which BINs are likely to fall below a threshold utilization value. As described above, the threshold utilization can be based on crossing a predetermined threshold or can be based on a prediction of the likelihood that BIN utilization will cross a threshold at some point in the future. The predictive nature of step 808 is important because once a threshold is crossed fees may be assessed. Accordingly predicting low BIN utilization before it occurs is important to properly manage BIN usage. It is also important not to identify BINs that, although nearing a utilization threshold, will not likely result in fees to avoid unnecessary restructuring or re-utilization of the BINs. In step 808, the processor can utilize the predictive model to better distinguish which BINs may cross a threshold before the threshold is crossed.

Referring to FIG. 8 at step 810, the processor can utilize the output of the predictive model applied to the data in step 808 and further identify BINs that are candidates to be discontinued or be repurposed. In some embodiments, any BIN that crosses a threshold for under utilization could be designated by the processor as a candidate for repurposing. Using the predictive model, the processor can be configured to predict and rank BINs based on the most likely that they will never again be utilized at a desired level. BINs ranking highest may be repurposed. The lower ranked BINs, although possible candidates, can be used for other purposes or left unchanged. Through this process, a financial institution (e.g., financial service provider 130 of system 100) can better optimize BIN usage to eliminate the most underutilized products and services as determined by BIN utilization. Moreover, the process 800 can be run in a continuous loop so that the ranking of BINs in step 810 can be updated in real-time or near real-time as new data becomes available. These continuous updates may allow for ongoing BIN optimization.

Referring to FIG. 8 at step 812, the processor can provide an indication of the BIN rankings determined in previous steps to a user. As shown above in FIGS. 4-6B, the indications can be provided through a dashboard (e.g., dashboard 440 and 500). Additionally, the indications may be provided as data, images, rendered form, or in another data format through a software API or remote procedure call that allows a third-party system to display the indications.

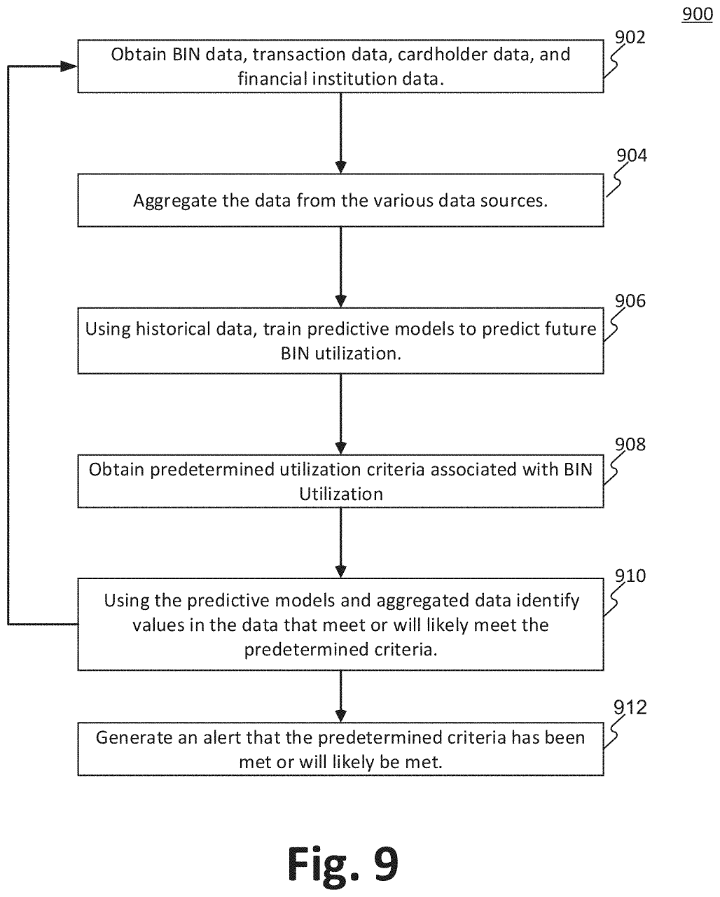

FIG. 9 is a flowchart of an example process 900 for analyzing financial data in system 100 and automated BIN utilization, consistent with the disclosed embodiments. Process 900 may be a process performed by a process performed by a computer-implemented system (e.g., server 200) in transaction processing network 120 or financial service provider 130. The computer-implemented system may include a memory (e.g., memory 230) that stores instructions and a processor (e.g., processor 210) programmed to execute the instructions to implement process 900. Process 900 may be connected to the analysis network and operations shown and described in FIGS. 3-4. For example, process 900 may be implemented as one or more software modules (e.g., an API in transaction analyzer 212) stored in memory 230 and executable by processor 210.

Referring to FIG. 9, at step 902, the processor may receive financial data from multiple data sources and from various components in system 100. The data may be stored in, for example, database 250, database 450, memory 230, or other components described above. The data may include, among other things, BIN data, cardholder data transaction data, or financial institution data.

Referring to FIG. 9, at step 904, the processor may aggregate the data received from the data sources. Because the data may originate from different systems, the data can be normalized so that common information has the same format and structure. For example, at step 904, the processor may normalize all account holder names to include three fields, first name, last name, and middle initial. In some embodiments, other data may be normalized such as addresses, financial institution names, date formats, or similar types of information. Additional examples of data normalization that the processor can apply to the input data includes, for example, identifying equivalent data through the use of phonetics, SOUNDEX, or Metaphone, removing extra whitespace, removing diacritics, or reformatting data, such as dates, phone numbers, and social security numbers into a standard format. After normalizing the data from the various data sources, the processor may combine or link the data records so that related data records can be easily inspected. For example, data that contains the account numbers can be broken into its component parts (e.g., BIN 320 and account identifier 330) and associated with, for example, other data sources that have information on the different BINs used by the financial institution.

Referring to FIG. 9, at step 906, the processor may analyze the historical data obtained and prepared in prior steps. The processor may create and train predictive models based on the usage patterns embedded in the historical data. Using various supervised and unsupervised training techniques, the processor can determine the predictive nature of different aspects of the data and different combinations of the data. For example, the processor can use machine learning to train models that determine what aspects of the historical data had the most value at predicting when BIN utilization dropped below a specified threshold. The processor can provide historical data as input and tell the system (e.g., analysis engine 420) the expected outcome and effect on, for example, BIN utilization, based on the historical data. The processor can provide historical data as input and tell the system (e.g., analysis engine 420) the expected outcome and effect on, for example, BIN utilization, based on the historical data. To accomplish this, the processor can train and use machine learning models. The processor can obtain historical data related BIN utilization and the transactions that contribute to the utilization. The processor can determine features of the input data and, using those features, analyze how each of the features contributes to a known utilization. As the amount of historical input and output data is analyzed, the model may become better at predicting expected BIN utilization based on the inputs. The processor can apply the predictive models to new data to make predictions. By using machine learning to train the models, bias regarding what data is the most significant can be removed and the processor can determine what data or combination of data has the most predictive value.

Referring to FIG. 9 at step 908, the processor can obtain criteria associated with BIN utilization. The processor can obtain the criteria directly from a user. In other embodiments, the processor can use criteria present in the predictive models. The criteria may be a specific threshold of BIN utilization or may be multiple factors that may be used to calculate a desired BIN utilization threshold.

Referring to FIG. 9 at step 910, the processor can use the predictive models, the aggregated data, and the provided criteria to identify BINs that meet or will likely meet the provided criteria. In some embodiments, the processor can apply the predictive model to identify intermediate criteria that the processor has determined, through the process of training the predictive models, to have predictive value in predicting the provided criteria. In these embodiments, the processor can identify data other than that specifically contemplated in the provided criteria that may indicate that the provided criteria will likely be met. For example, the processor may determine that changes in per card transaction rates within a BIN are highly predictive of whether a BIN will become under-utilized. In this example, the processor, at step 910 can establish per card transaction rates as relevant criteria for determining that BINs will cross or meet the provided utilization threshold. As described above, the processor can rely on the models crated through machine learning to identify data with predictive value that otherwise might be ignored. The processor can provide the results of its analysis at step 910 to step 912. Additionally, or alternatively, the processor can rerun the process beginning at step 902. In these embodiments, the processor can run process 900 continuously to regular update the calculated predictions and models. In these embodiments the data and results can be updated in real time or near real-time as new data is provided.

Referring to FIG. 9 at step 912, the processor can generate alerts or notifications that the provided criteria has been met or will likely be met in the future. The notifications can be based on measuring the provided criteria against the available. In other embodiments, the notifications may be based on evaluating data the processor determined has high predictive value for predicting whether a BIN will meet the provided criteria in the future. By way of example, alerts may be sent via text message, e.g., SMS or MMS, push notifications, electronic mail, automatic calling, or any other suitable communication protocol. In some embodiments, the processor can cause the alerts to be displayed on a dashboard (e.g., dashboard 440 of FIG. 4).

A non-transitory computer-readable medium may be provided that stores instructions for a processor (e.g., processor 210) for processing financial data according to the example flowcharts of FIGS. 7-9 above, consistent with embodiments in the present disclosure. For example, the instructions stored in the non-transitory computer-readable medium may be executed by the processor for performing process 700, 800, or 900 in part or in entirety. Common forms of non-transitory media include, for example, a floppy disk, a flexible disk, hard disk, solid-state drive, magnetic tape, or any other magnetic data storage medium, a Compact Disc Read-Only Memory (CD-ROM), any other optical data storage medium, any physical medium with patterns of holes, a Random Access Memory (RAM), a Programmable Read-Only Memory (PROM), and Erasable Programmable Read-Only Memory (EPROM), a FLASH-EPROM or any other flash memory, Non-Volatile Random Access Memory (NVRAM), a cache, a register, any other memory chip or cartridge, and networked versions of the same.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, R, Python, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computer-implemented system comprising:
a non-transitory computer-readable medium configured to store instructions; and
at least one processor configured to execute the instructions to perform operations comprising:
obtaining, from at least one data store, at least one historical data record associated with a financial institution;
aggregating the at least one historical data record based on related attributes in the at least one historical data record;
generating a predictive model configured to predict future BIN utilization;
using the at least one historical data record, training the predictive model;
obtaining, from at least one data store, at least one non-historical data record associated with the financial institution;
determining, by applying the predictive models to the at least one non-historical data record, one or more BINs that do not meet a predetermined utilization; and
generating a visualization of at least one of the at least one non-historical or at least one historical data record, wherein the visualization includes an indication of BINs that do not meet the predetermined utilization.

2. The computer-implemented system of claim 1, wherein the operations further comprise:
displaying the visualization on a graphical user interface.

3. The computer-implemented system of claim 1, wherein the operations further comprise:
providing the visualizations as data over a network.

4. The computer-implemented system of claim 1, wherein applying the predictive models to the one or more non-historical data records further comprises:
identifying intermediate criteria in the non-historical data, wherein the intermediate criteria has predictive value for determining BIN utilization.

5. The computer-implemented system of claim 1, wherein training the predictive model further comprises using at least one of supervised learning, unsupervised learning, or semi-supervised learning to train the model.

6. The computer-implemented system of claim 1, wherein visualization includes an indication of utilization of one or more BINs owned by the financial institution.

7. The computer-implemented system of claim 1, wherein the visualization includes an indication of utilization of one or more BINs owned by the financial institution and wherein the utilization is determined based on the ratio of active and inactive payment cards associated with the one or more BINs.

8. The computer-implemented system of claim 1, wherein the visualization includes an indication of utilization of one or more BINs owned by the financial institution and wherein the utilization is determined based on an analysis of the number of payment cards issued for the one or more BINs.

9. The computer-implemented system of claim 1, wherein the visualization includes an indication of utilization of one or more BINs owned by the financial institution and wherein the utilization is determined based on an analysis of the number of payment cards issued for the one or more BINs.

10. The computer-implemented system of claim 1, wherein the operations further comprise:
generating an alert associated with the indication of BINs that do not meet the predetermined utilization; and
providing the alert for display to a user.

11. A computer-implemented method comprising:
a non-transitory computer-readable medium configured to store instructions; and
at least one processor configured to execute the instructions to perform operations comprising:
obtaining, from at least one data store, at least one historical data record associated with a financial institution;
aggregating the at least one historical data record based on related attributes in the at least one historical data record;
generating a predictive model configured to predict future BIN utilization;
using the at least one historical data record, training the predictive model;
obtaining, from at least one data store, at least one non-historical data record associated with the financial institution;
determining, by applying the predictive models to the at least one non-historical data record, one or more BINs that do not meet a predetermined utilization; and
generating a visualization of at least one of the at least one non-historical or at least one historical data record, wherein the visualization includes an indication of BINs that do not meet the predetermined utilization.

12. The computer-implemented method of claim 11, further comprising:
displaying the visualization on a graphical user interface.

13. The computer-implemented method of claim 11, further comprising:
providing the visualizations as data over a network.

14. The computer-implemented method of claim 11, wherein applying the predictive models to the one or more non-historical data records further comprises:
identifying intermediate criteria in the non-historical data, wherein the intermediate criteria has predictive value for determining BIN utilization.

15. The computer-implemented method of claim 11, wherein training the predictive model further comprises using at least one of supervised learning, unsupervised learning, or semi-supervised learning to train the model.

16. The computer-implemented method of claim 11, wherein visualization includes an indication of utilization of one or more BINs owned by the financial institution.

17. The computer-implemented method of claim 11, wherein the visualization includes an indication of utilization of one or more BINs owned by the financial institution and wherein the utilization is determined based on the ratio of active and inactive payment cards associated with the one or more BINs.

18. The computer-implemented method of claim 11, wherein the visualization includes an indication of utilization of one or more BINs owned by the financial institution and wherein the utilization is determined based on an analysis of the number of payment cards issued for the one or more BINs.

19. The computer-implemented method of claim 11, wherein the visualization includes an indication of utilization of one or more BINs owned by the financial institution and wherein the utilization is determined based on an analysis of the number of payment cards issued for the one or more BINs.

20. The computer-implemented method of claim 11, wherein the operations further comprise:
generating an alert associated with the indication of BINs that do not meet the predetermined utilization; and
providing the alert for display to a user.
